(19) United States
(12) Patent Application Publication
(10) Pub. No.: US 2007/0035596 A1
(43) Pub. Date: Feb. 15, 2007

(54) Ink jet cartridge

(75) Inventors: Trevor Daniel Gray, Midway, KY (US); David E. Greer, Lexington, KY (US); Gina Marie Johns, Nicholasville, KY (US); Bhaskar Tirukalikundram Ramakrishnan, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/201,055

(22) Filed: Aug. 10, 2005

(51) Int. Cl. B41J 2/175

(52) U.S. Cl. 347/86

(57) ABSTRACT

An ink jet cartridge for use in an ink jet printer. In one embodiment, the ink jet cartridge has an ink tank configured to hold a first capacity of ink. The ink tank comprises a negative pressure producing material containing chamber and a free ink chamber. A lid configured to seal the negative pressure producing material containing chamber and free ink chamber of the ink tank is adapted to reduce the volume of the ink tank from a first capacity to a second capacity of ink. A method of manufacturing the same is provided.

### TECHNICAL FIELD

The present invention relates to ink jet cartridges for use with an ink jet printer, and more specifically to a unique ink jet cartridge adapted to contain a reduced volume of ink.

### BACKGROUND OF THE INVENTION

Ink jet printing is a conventional technique by which printing is accomplished without contact between the printing apparatus and the substrate, or medium, on which the desired print characters are deposited. Such printing is accomplished by ejecting ink from the ink jet printhead of the printing apparatus via numerous methods which employ, for example, pressurized nozzles, electrostatic fields, piezo-electric elements and/or heaters for vapor phase droplet formation.

The ink jet printhead can comprise an ink reservoir, a pressure regulator, and an ink ejection chip with nozzles and corresponding ink ejection actuators, such as heaters. Ink is ejected from the nozzles onto a print medium at selected ink dot locations within an image area. A carrier moves the printhead relative to the medium, while the ink dots are jetted onto selected pixel locations, such as by heating the ink at the nozzles.

In some such systems, the ink reservoir comprises a removable tank, such that the tank can be removed and replaced or refilled, when the ink is low. The remainder of the printhead components can then be reused. In other ink tank systems, the ink reservoir is integrated with the ink jetting features into a single cartridge.

In typical thermal ink jet printers, the ink reservoir comprise one or more ink-filled channels communicating with a relatively small supply chamber, or manifold, at one end, and having an opening at the opposite end, referred to as a nozzle. Ink jet printers require an ink supply to be in fluid contact with an ink drop ejecting device which precisely ejects ink onto the recording media. The ink supply must be maintained at a relatively constant pressure to keep the ink from discharging from the ejection device at the wrong time or in an undesired amount. There are several methods and devices for maintaining a constant negative back-pressure in the ink tank, including but not limited to utilization of negative pressure producing materials such as capillary fibers or foam, bladder-type configurations and lung-type configurations.

A conventional inkjet cartridge 30 is illustrated in FIG. 1. The ink jet cartridge 30 comprises one or more ink tanks 32 and a lid 35. The ink tank 32 is configured to hold a first capacity of ink. The ink tank 32 further comprises a negative pressure producing material containing chamber 40 and a free ink chamber 50. The volume of the free ink chamber is important in several ways. The volume of the free ink chamber controls the amount of deliverable ink that can be contained in the ink jet cartridge. In addition, the volume can affect the performance requirements of the negative pressure producing material 41 (felt or foam portion) in the negative pressure producing material containing chamber 40 during shipment, atmospheric changes, and the like.

During an atmospheric change, the negative pressure producing material containing chamber 40 should be configured to accommodate the ink forced from the free ink chamber 50 due to the increase in volume of the existing air in the free ink chamber 50. While not being limited to a theory, it is believed that the volume increase of the air in the ink jet cartridge is determined by the ideal gas law: P₁V₁=P₂V₂. Therefore, the initial volume of the air and the pressure change dictate the final volume of the air in the ink jet cartridge. This change in volume will force an equal amount of ink from the free ink chamber to the negative pressure producing material containing chamber, provided that a substantial amount of ink still resides in the free ink chamber. In order to maintain the desired negative pressure, the negative pressure producing material containing chamber comprises negative pressure producing material (such as felt or foam) configured to absorb the volume of the ink, while maintaining the desired negative pressure. As such, the total volume in the free ink chamber of the ink tank plays an important role in the performance and reliability of the ink jet cartridge.

New and improved inks and specialty inks continue to be developed for ink jet printers. It is desirable that these new and improved inks can be utilized in present ink jet printers having a specific replaceable ink tank configuration, wherein the ink tank is adapted to hold a first capacity of ink. However, due to the specialty nature of the ink, there may be a desire by the user to purchase a smaller quantity of the specialty ink than the first capacity of ink for which the ink tank was originally configured to hold. As such, the ability to modify the volume of an ink jet cartridge without altering the ink tank geometry and footprint of the ink cartridge is very desirable. Typically, ink cartridges are configured to fit a predetermined footprint in the printer apparatus. In addition, the ink cartridge may carry electrical circuit information and be configured to be in electrical communication with a printer. For these and other reasons, it is difficult to utilize a smaller ink jet cartridge having a different footprint. As such, there is a need for an ink jet cartridge comprising an ink tank originally configured to hold a first capacity of ink, being adapted such that it holds a second reduced quantity of ink. Accordingly, improved ink jet cartridges and apparatus using the same are desired.

### SUMMARY OF THE INVENTION

The present invention relates to an ink jet cartridge configured to hold a reduced capacity of ink. One aspect of the present invention is an ink jet cartridge for use in an ink jet printer. The ink jet cartridge comprises an ink tank configured originally to hold a first capacity of ink, wherein the ink tank comprises a negative pressure producing material containing chamber and a free ink chamber, and wherein the negative pressure producing material containing chamber and the free ink chamber are in fluid communication with each other. The ink jet cartridge further comprises a lid adapted to seal the negative pressure producing material containing chamber and the free ink chamber of the ink tank. The lid is adapted to reduce the first capacity of the ink tank to a second capacity.

Another aspect of the present invention is a method of manufacturing an ink jet cartridge. The method comprises: providing an ink tank, wherein the ink tank has a plurality of walls that define an interior space, wherein the interior space is further divided into chambers, wherein the ink tank comprises at least one free ink chamber having a capacity of a first volume of ink; providing a lid adapted to occupy a predetermined amount of the free ink chamber thereby reducing the capacity to a second volume of ink; and attaching the lid to the ink tank such that the lid seals the ink tank and reduces the capacity of the at least one free ink chamber from the first volume to the second volume.

The methods and ink jet cartridges of the present invention are advantageous for providing an ink jet cartridge originally configured to hold a first capacity of ink and reduced to hold a second capacity of ink. These and additional advantages will be apparent in view of the detailed description.

### BRIEF DESCRIPTION OF THE DRAWINGS

While the specification concludes with claims particularly pointing out and distinctly claiming the present invention, it is believed the same will be better understood from the following description taken in conjunction with the accompanying drawings in which:

FIG. 1 is a schematic illustration of an exemplary prior art ink jet cartridge;

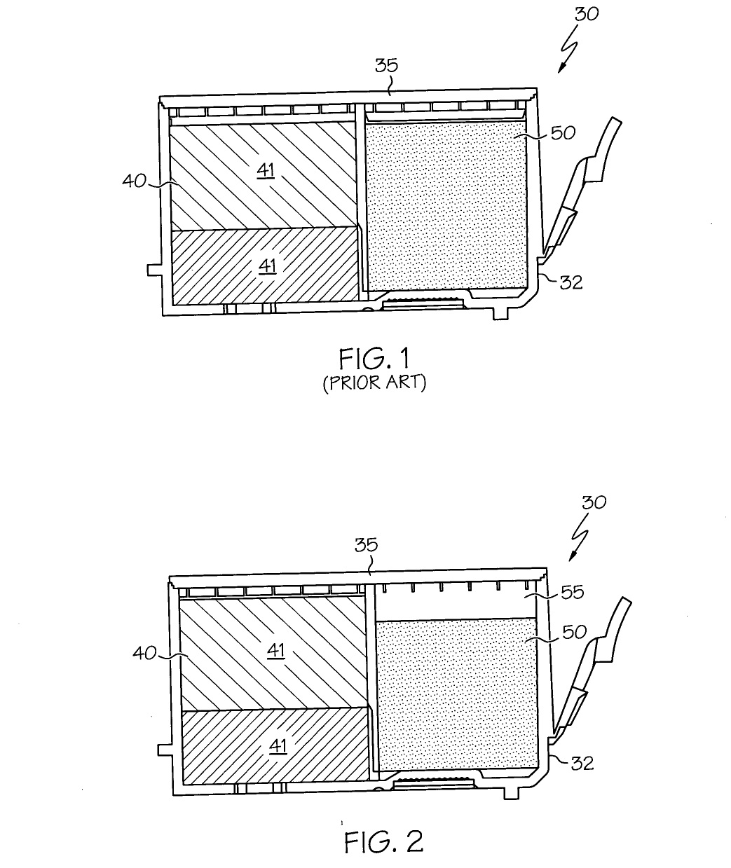

FIG. 2 is a schematic illustration of an exemplary ink jet cartridge according to a first embodiment of the present invention; and

FIGS. 3A-C are schematic illustrations of exemplary ink jet cartridges according to another embodiment of the present invention.

The embodiments set forth in the drawings are illustrative in nature and not intended to be limiting of the invention defined by the claims. Moreover, individual features of the drawings and the invention will be more fully apparent and understood in view of the detailed description.

### DETAILED DESCRIPTION OF THE INVENTION

Reference will now be made in detail to various embodiments which are illustrated in the accompanying drawings, wherein like numerals indicate similar elements throughout the views.

As noted, a user and/or manufacturer may desire a replacement ink cartridge containing a reduced quantity of ink for their current printer which requires a certain ink jet cartridge footprint to ensure proper printing and electrical connection to the printer. Merely reducing the amount of ink initially filled in the ink jet cartridge without decreasing the chamber volume of the ink tank can lead to displacement of an undesirable amount of ink during an atmospheric pressure change (such as during shipment, etc.) and potentially cause drooling of ink from the ink jet cartridge in the user's printer.

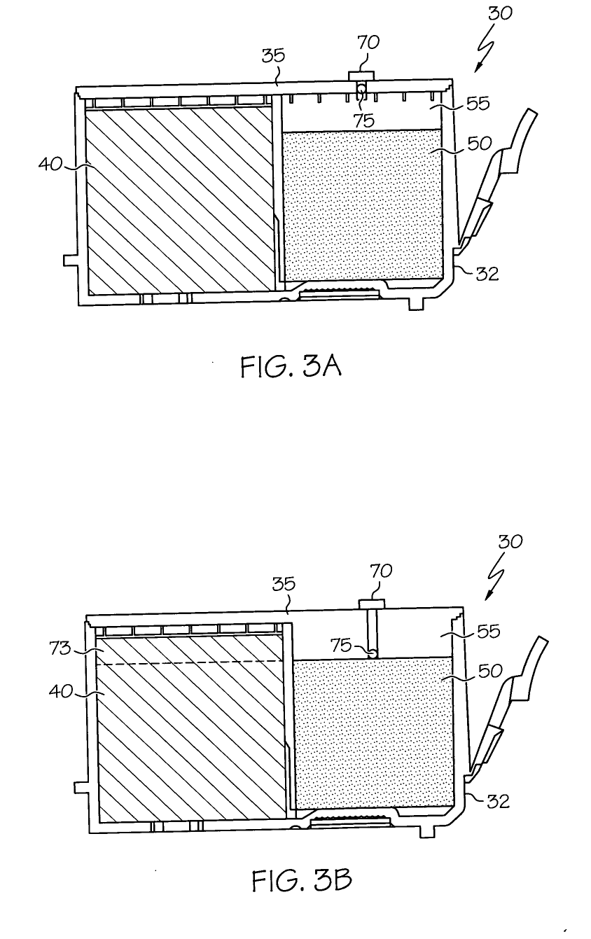

One embodiment of the present invention is illustrated in FIG. 2. In this embodiment, the ink jet cartridge 30 comprises an ink tank 32 configured to hold a first capacity of ink. The ink tank 32 comprises a negative pressure producing material containing chamber 40 and a free ink chamber 50. The negative pressure producing material containing chamber 40 and the free ink chamber are in fluid communication. In one exemplary embodiment, the negative pressure producing material containing chamber may comprise one or more negative pressure producing materials to help create and maintain a negative pressure in the ink jet cartridge. The lid 35 is adapted to seal the negative pressure producing material containing chamber 40 and the free ink chamber 50. In this embodiment, the lid 35 is adapted to reduce the first capacity of the ink tank to a second capacity utilizing a thicker portion 55.

The ink tank 32 and lid 35 may be constructed with any materials known to one skilled in the art. Exemplary materials include but are not limited to polymers, plastics, ceramics, metal, fabric, wood and the like. In one exemplary embodiment, the ink tank 32 is molded from a polymeric material selected from the group consisting of glass-filled polybutylene terephthalate available from G.E. Plastics of Huntersville, N.C. under the trade name VALOX 855, amorphous thermoplastic polyetherimide available from G.E. Plastics under the trade name ULTEM 1010, glass-filled thermoplastic polyethylene terephthalate resin available from Dow Chemical Company of Midland, Mich., under the trade name QUESTRA, polyphenylene ether/polystyrene alloy resin available from G.E. Plastics under the trade name NORYL SEI and NORYL 300X and polyamide/poly-phenylene ether alloy resin available from G.E. Plastics under the trade name NORYL GTX or a polypropylene material. In one exemplary embodiment, the lid 35 comprises a polymeric material selected from the group consisting of glass-filled polybutylene terephthalate available from G.E. Plastics of Huntersville, N.C. under the trade name VALOX 855, amorphous thermoplastic polyetherimide available from G.E. Plastics under the trade name ULTEM 1010, glass-filled thermoplastic polyethylene terephthalate resin available from Dow Chemical Company of Midland, Mich., under the trade name QUESTRA, polyphenylene ether/polystyrene alloy resin available from G.E. Plastics under the trade name NORYL SEI and NORYL 300X and polyamide/poly-phenylene ether alloy resin available from G.E. Plastics under the trade name NORYL GTX or a polypropylene material.

In one exemplary embodiment, the negative pressure producing material containing chamber comprises a conventional hydrophobic foam material, for example, an unfelted polyurethane open cell foam. In another exemplary embodiment, the negative pressure producing material comprises one or more fiber materials, for example, polyethylene, polypropylene, polyester, or any blend thereof. While not being limited to a theory, the wick material in the negative pressure producing material containing chamber uses capillary action to retain ink. When saturated with liquid (such as ink), the capillary action of the negative pressure producing material facilitates maintaining the negative pressure for proper operation of the ink jet cartridge. As one skilled in the art will appreciate, the specific material utilized to provide the capillary action can be different and selected among any of those materials known to one skilled in the art.

In another embodiment, the thicker portion 55 is adapted to extend into the free ink chamber. In one embodiment, the thicker portion 55 is configured to reduce the first capacity of the ink tank by at least 10% by volume. In an alternative embodiment, the thicker portion 55 is configured to reduce the first capacity of the ink tank by at least 25% by volume. In one exemplary embodiment, the first capacity of the ink tank ranges from about 7.5 ml to about 10 ml and the second capacity of the ink tank ranges from about 4.5 ml to 7.4 ml.

By extending a portion 55 of the lid 35 into the free ink chamber 50, the volume of the free ink chamber 50 can be modified without changing the critical geometry of the ink tank 32, such as the bubble generator as well as any electrical contacts, etc. on the exterior of the ink jet cartridge 30. As one skilled in the art will appreciate, the shape and the form of the lid portion 55 extended into the free ink chamber can take nearly any shape and is not limited to the illustrated embodiment.

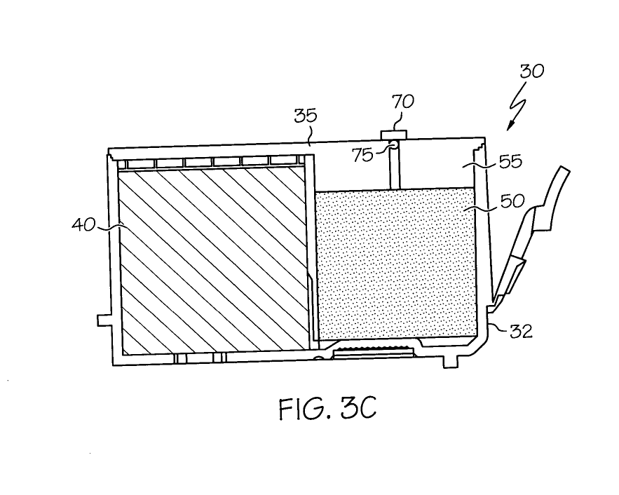

Another embodiment of the present invention is illustrated in FIG. 3. In this embodiment, the ink cartridge 30 is configured to allow easy filling of ink while minimizing the amount of air in the free ink chamber 50. In typical ink cartridges, a valve 75 is utilized to seal the filling port 70 of the free ink chamber 50 of the ink tank 32. In one exemplary embodiment of the present invention illustrated in FIG. 3B, the valve 75 extends below the surface of the inside lid 35. As such, when the ink tank is filled through this port 70 in an upright fashion, there may be some air portion 73 remaining in the chambers of the ink jet cartridge. In another exemplary embodiment illustrated in FIG. 3C, the valve 75 is configured to be at the top of the port 70 in the extended portion 55 of the lid. In this configuration, since the valve is located physically above any portion of the free ink tank 55 and wick tank 40, the amount of air remaining in the ink tank during filling can be greatly reduced. As such, the ink tank can be filled upright without a significant amount of residual air remaining in the ink tanks. As such, placement of the valve 75 in the fill port 70 can vary depending on which method allows for better management of air on the free ink side for that particular ink system.

Another aspect of the present invention is a method of manufacturing an ink jet cartridge having a reduced capacity of ink while maintaining the originally configured footprint of the ink jet cartridge. The method comprises providing an ink tank. The ink tank has a plurality of walls that define an interior space, wherein the interior space is further divided into chambers. The ink tank comprises at least one free ink chamber having a capacity of a first volume of ink. A lid is provided to occupy a predetermined amount of the free ink chamber of the ink tank to reduce the capacity of the free ink tank to a second volume of ink. The lid is attached to the ink tank such that the lid seals the ink tank and reduces the capacity of the at least one free ink chamber from the first volume to a second volume of ink.

The foregoing description of the various embodiments and principles of the invention has been presented for the purposes of illustration and description. It is not intended to be exhaustive or to limit the inventions to the precise forms disclosed. Many alternatives, modifications and variations will be apparent to those skilled in the art. For example, some principals of the invention may be used in different ink jet tank configurations and types of ink jet printers. Moreover, although multiple inventive aspects have been presented, such aspects need not be utilized in combination, and various combinations of inventive aspects are possible in light of the various embodiments provided above. Accordingly, the above description is intended to embrace all possible alternatives, modifications, combinations, and variations that have been discussed or suggested herein, as well as all others that fall within the principals, spirit and broad scope of the invention as defined by the claims.

What is claimed:

1. An ink jet cartridge for use in an inkjet printer, comprising:
an ink tank configured to hold a first capacity of ink, wherein the ink tank comprises a negative pressure producing material containing chamber and a free ink chamber, and wherein the negative pressure producing material containing chamber and the free ink chamber are in fluid communication; and
a lid adapted to seal the free ink chamber of the ink tank, wherein the lid is adapted to reduce the first capacity of the ink tank to a second capacity.

2. The inkjet cartridge of claim 1, wherein the lid seals substantially all of the free ink tank chamber.

3. The inkjet cartridge of claim 1, wherein the lid covers the negative pressure producing material containing chamber, with the exception of a vent.

4. The ink tank cartridge of claim 1, wherein the lid seals the free ink chamber and substantially all of the negative pressure producing material containing chamber, except for a vent in the negative pressure producing material containing chamber, and wherein further the portion of the lid that covers the free ink chamber extends deeper into the free ink tank chamber than that portion of the lid that covers the negative pressure producing material containing chamber.

5. The ink jet cartridge of claim 1, wherein the first capacity of ink ranges from 7.5 ml or more and wherein the second capacity of ink is less than 7.5 ml.

6. The ink jet cartridge of claim 1, wherein the lid comprises an extension portion adapted to extend into the free ink chamber.

7. A method of manufacturing an ink jet cartridge, comprising:
providing an ink tank, wherein the ink tank has a plurality of walls that define an interior space, wherein the interior space is further divided into chambers, wherein the ink tanks comprises at least one free ink chamber having a capacity of a first volume of ink;
providing a lid adapted to occupy a predetermined amount of the free ink chamber reducing the capacity to a second volume of ink;
attaching the lid to the ink tank, such that the lid seals the at least one free ink chamber and reduces the capacity of the at least one free ink chamber from the first volume to the second volume.
